(19) United States
(12) Patent Application Publication
(10) Pub. No.: US 2018/0275930 A1
(43) Pub. Date: Sep. 27, 2018

(54) INFORMATION COLLECTING SYSTEM AND IMAGE FORMING APPARATUS

(71) Applicant: FUJI XEROX CO., LTD., Tokyo (JP)

(72) Inventors: Ryuichi ISHIZUKA, Tokyo (JP); Eiji NISHI, Kanagawa (JP); Yoshihiro SEKINE, Kanagawa (JP); Kenji KUROISHI, Kanagawa (JP); Hiroshi MIKURIYA, Kanagawa (JP); Takeshi FURUYA, Kanagawa (JP); Keita SAKAKURA, Kanagawa (JP)

(73) Assignee: FUJI XEROX CO., LTD., Tokyo (JP)

(21) Appl. No.: 15/893,797

(22) Filed: Feb. 12, 2018

(30) Foreign Application Priority Data
Mar. 24, 2017 (JP) 2017-059544

(51) Int. Cl. G06F 3/12

(52) U.S. Cl. CPC G06F 3/1236; G06F 3/1286; G06F 3/1293

(57) ABSTRACT

An information collecting system includes: an information processing apparatus; and an image forming apparatus that form an image on a recording material in accordance with an image formation command received from the information processing apparatus. The information processing apparatus includes an information acquisition unit that acquires specific information and a transmission control unit that transmits transmission data including the specific information acquired by the information acquisition unit to the image forming apparatus by using a communication protocol for the image formation command. The image forming apparatus includes an information extraction unit that extracts the specific information from the transmission data received from the information processing apparatus and an information holding unit that holds the specific information extracted from the transmission data by the information extraction unit.

### CROSS-REFERENCE TO RELATED APPLICATIONS

This application is based on and claims priority under 35 USC 119 from Japanese Patent Application No. 2017-059544 filed Mar. 24, 2017.

### BACKGROUND

### Technical Field

The present invention relates an information collecting system and an image forming apparatus.

### SUMMARY

According to an aspect of the invention, there is provided an information collecting system including: an information processing apparatus; and an image forming apparatus that forms an image on a recording material in accordance with an image formation command received from the information processing apparatus, wherein the information processing apparatus includes an information acquisition unit that acquires specific information and a transmission control unit that transmits transmission data including the specific information acquired by the information acquisition unit to the image forming apparatus by using a communication protocol for the image formation command, and wherein the image forming apparatus includes an information extraction unit that extracts the specific information from the transmission data received from the information processing apparatus and an information holding unit that holds the specific information extracted from the transmission data by the information extraction unit.

### BRIEF DESCRIPTION OF THE DRAWINGS

An exemplary embodiment of the present invention will be described in detail based on the following figures, wherein:

FIG. 1 illustrates an overall configuration of an information collecting system according to the present exemplary embodiment;

FIG. 2 illustrates a configuration of a personal computer that is an example of an information acquisition terminal;

FIG. 3 illustrates a functional configuration realized by execution of a program by a CPU in the information acquisition terminal;

FIG. 4 illustrates a configuration of a multi-function printer that is an example of an information collecting server;

FIG. 5 illustrates a functional configuration of a controller;

FIGS. 6A and 6B each illustrate an example of a configuration of transmission data, FIG. 6A illustrates an example of transmission data in a case where only acquired data is transmitted, and FIG. 6B illustrates an example of transmission data in a case where acquired data and a printing instruction are transmitted;

FIG. 7 is a flowchart illustrating an operation of an information acquisition terminal in a case where acquired data is promptly transmitted;

FIG. 8 is a flowchart illustrating an operation of an information acquisition terminal in a case where acquired data is transmitted together with a printing instruction; and

FIG. 9 is a flowchart illustrating an operation of an information collecting server in a case where communication is performed by using a printing protocol and a printer port.

### DETAILED DESCRIPTION

An exemplary embodiment of the present invention is described in detail below with reference to the attached drawings.

### System to Which Present Exemplary Embodiment is Applied

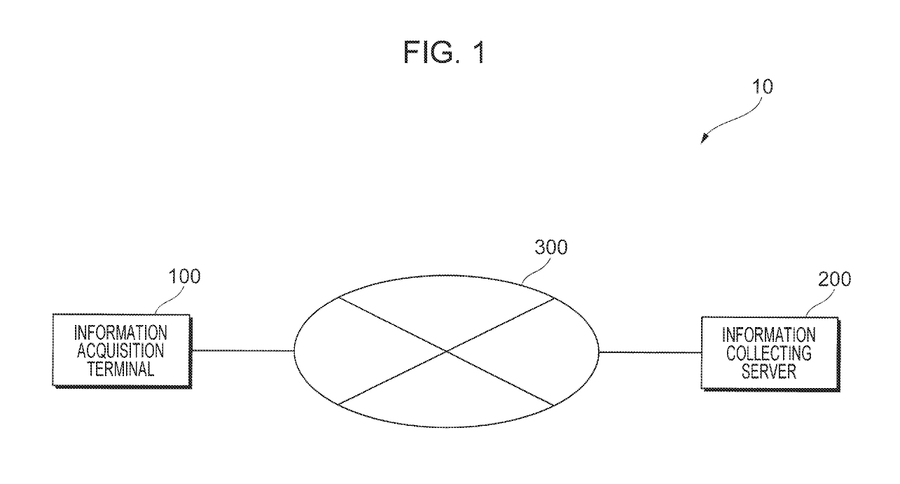

FIG. 1 illustrates an overall configuration of an information collecting system according to the present exemplary embodiment. An information collecting system 10 illustrated in FIG. 1 includes an information acquisition terminal 100 and an information collecting server 200. The information acquisition terminal 100 and the information collecting server 200 are connected over a network 300. Although a single information acquisition terminal 100 is illustrated in FIG. 1, plural information acquisition terminals 100 are connected to the information collecting server 200 in an actual information collecting system 10. The information collecting server 200 may be connected to other servers (external servers) (not illustrated in FIG. 1) over the network 300. In this case, the information collecting server 200 functions as an edge server in an information system including the other servers on the network.

The information acquisition terminal 100 is an information processing apparatus that performs various kinds of information processing and acquires information to be collected in the information collecting system 10 of the present exemplary embodiment. The information acquisition terminal 100 is, for example, an information apparatus individually used by an office employee. Specific examples of the information acquisition terminal 100 include a personal computer and a mobile information terminal (a tablet PC or a smartphone).

The information acquisition terminal 100 includes an information acquisition unit that acquires information to be collected. The information to be collected is not limited in particular. The information acquisition unit provided in the information acquisition terminal 100 varies depending on what kind of information is collected. For example, in a case where environment information such as temperature, humidity, illuminance, acceleration, vibration, and the presence or absence of or a density of dust or a specific component in the air is acquired, various kinds of sensors that acquire such physical amounts are used as information acquisition units. Furthermore, various measuring devices such as a clock for measuring time and a counter for measuring the number of repetitions of a specific operation and the number of specific things may be used as information acquisition units. The information to be acquired is not limited to environment information but may be any information such as the number of specific actions or operations in the information acquisition terminal 100, periods for which the specific actions or operations are continuously performed, time intervals (intervals) between the actions or operations, whether a specific apparatus is connected or not, and whether power is being supplied or not, provided that such information is information that can be acquired as electronic data by a measuring device. For example, biological information (e.g., breathing, a pulse, a fingerprint, a voiceprint, a face part) of an operator of the information acquisition terminal 100 may be acquired. In a case where a personal computer is used as the information acquisition terminal 100, information concerning key input of a keyboard, mouse operation, and the like such as the number of entered keys, an operation period, a period in which no operation is performed may be collected.

A measuring device for acquiring information may be included in the information acquisition terminal 100 or may be provided as an external device connected through a bus such as a universal serial bus (USB) or IEEE1394. In a case where an external device connected through a bus is used as a measuring device, the external device need only have a function of acquiring information as data that can be read by the information acquisition terminal 100 and need not have a communication function of transmitting the acquired data. Furthermore, in a case where the measuring device is connected to the information acquisition terminal 100 through a bus, such as a USB or IEEE1394, having a power feeding function, electric power is supplied to the measuring device through the bus, and therefore the measuring device itself need not have a power source and need not be connected to a power source.

The information collecting server 200 is a server that collects information acquired by the information acquisition terminal 100. In the present exemplary embodiment, an operation apparatus that performs a special operation by information processing and that communicates with the information acquisition terminal 100 by using unique protocol and port is used as the information collecting server 200. In the present exemplary embodiment, an example in which an image forming apparatus that is a multi-function printer having functions such as a copying function, an image reading function, a printing function, and a facsimile communication function and has a communication function for connecting to the network 300 is used as the information collecting server 200 is described. That is, a printing protocol and a printer port are used for communication between the information acquisition terminal 100 and the information collecting server 200.

The network 300 is a communication network used for data communication between the information acquisition terminal 100 and the information collecting server 200. A local area network (LAN) is used as the network 300. A communication line used for the data communication may be wired or may be wireless.

### Configuration of Information Acquisition Terminal

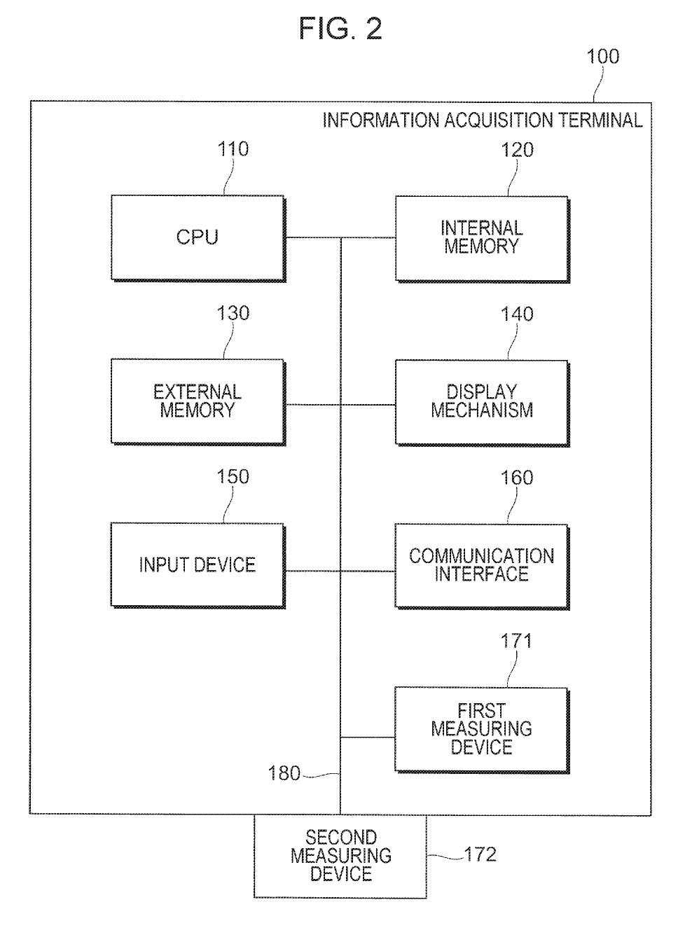

FIG. 2 illustrates a configuration of a personal computer (hereinafter referred to as a “PC”) that is an example of the information acquisition terminal 100. As illustrated in FIG. 2, the PC that serves as the information acquisition terminal 100 includes a central processing unit (CPU) 110, an internal memory 120, an external memory 130, a display mechanism 140, an input device 150, a communication interface 160, a first measuring device 171, and a second measuring device 172.

The CPU 110 is an arithmetic processing unit and realizes various functions by executing a program. The internal memory 120 is used as a working memory during execution of processing by the CPU 110. A random access memory (RAM) is, for example, used as the internal memory 120. The external memory 130 stores therein a program executed by the CPU 110 and a result of processing performed by the CPU 110. The program stored in the external memory 130 is loaded into the internal memory 120 so that the program can be executed by the CPU 110. A hard disk drive (HDD) or a solid state drive (SSD) is, for example, used as the external memory 130.

The display mechanism 140 is one of output units of the PC and displays an image and a text on a display device (not illustrated). The input device 150 is one of input units of the PC, and a keyboard, a mouse, and the like are used as the input device 150. The communication interface 160 is an interface for connection to the network 300. For example, a network adapter for connection through wired communication or a Wi-Fi (Registered Trademark) module for connection through wireless communication is used as the communication interface 160. The first measuring device 171 is a sensor that serves as an information acquisition unit and is included in the PC that serves as the information acquisition terminal 100. The second measuring device 172 is a sensor that serves as an information acquisition unit and is an external device that is connected to the PC that serves as the information acquisition terminal 100 through a bus 180 (e.g., a USB) (hereinafter the first measuring device 171 and the second measuring device 172 are referred collectively as “measuring devices 171 and 172” in a case where the first measuring device 171 and the second measuring device 172 are not distinguished).

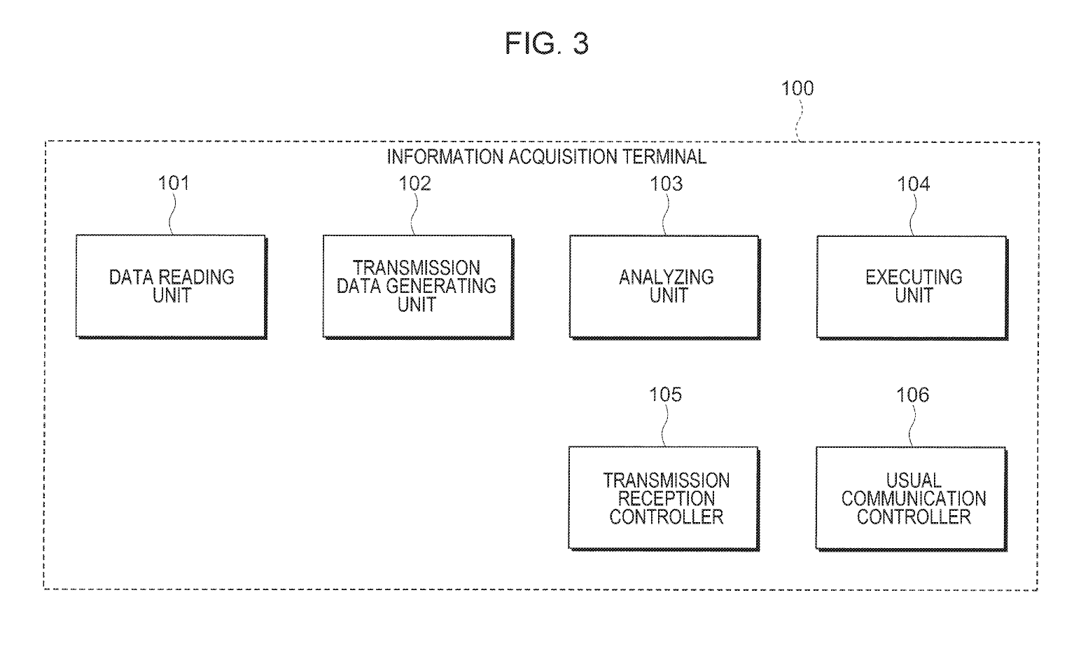

FIG. 3 illustrates a functional configuration realized by execution of the program by the CPU 110 in the information acquisition terminal 100. As illustrated in FIG. 3, the information acquisition terminal 100 includes a data reading unit 101, a transmission data generating unit 102, an analyzing unit 103, an executing unit 104, a transmission reception controller 105, and a usual communication controller 106.

The data reading unit 101 reads data acquired by the measuring devices 171 and 172 in a case where a predetermined reading condition is met. The reading condition may be individually set for each kind of information to be acquired. For example, in a case where data is regularly read, a reading interval is set, and the data is read at the set time intervals. Alternatively, reading of data may be triggered by a predetermined event. Data read by the data reading unit 101 is stored in a memory such as the internal memory 120 or the external memory 130.

The transmission data generating unit 102 acquires data read by the data reading unit 101 and stored in the memory and then generates transmission data to be transmitted to the information collecting server 200. In the present exemplary embodiment, data is transmitted through communication using unique protocol and port used for communication between the information acquisition terminal 100 and the information collecting server 200. The transmission data generating unit 102 generates transmission data from data read by the data reading unit 101 on the basis of the unique protocol. As described above, in a case where an image forming apparatus is used as the information collecting server 200, transmission data is generated on the basis of a printing protocol. Details of the transmission data and generation thereof will be described later.

The analyzing unit 103 is an information extraction unit that analyzes reception data received from the information collecting server 200 and thereby extracts an execution command to execute processing or control. In the present exemplary embodiment, unique protocol and port may be used for data communication from the information collecting server 200 to the information acquisition terminal 100, as in the case of transmission data. The analyzing unit 103 extracts a specific execution command from data received through communication using the unique protocol and port.

The executing unit 104 executes various kinds of processing and control in accordance with a command described in a program. The executing unit 104 also executes an execution command extracted from data received through communication using the unique protocol and port by the analyzing unit 103.

The transmission reception controller 105 controls data transmission and reception using the unique protocol and port used for communication with the information collecting server 200. The transmission reception controller 105 transmits transmission data generated by the transmission data generating unit 102 to the information collecting server 200 by using the unique protocol and port (e.g., a printing protocol and a printer port) in a case where a predetermined transmission condition is met. The transmission condition may be individually set, for example, depending on the kind of information to be collected or the specifications of the information collecting system 10. For example, transmission data is transmitted as soon as the transmission data is generated by the transmission data generating unit 102 in a case where the transmission data is timely data. In a case where the transmission data is less timely data, the transmission data may be regularly transmitted at predetermined time intervals. Alternatively, an irregular method may be employed in which the transmission data is regularly transmitted in principle but is transmitted promptly in a case where the acquired data exceeds a predetermined threshold value. Alternatively, it is also possible to employ a method in which a monitoring unit that monitors an operation status of the input device 150 or a network load in the information acquisition terminal 100 is prepared, and data is transmitted after the load becomes lower than a certain value in a case where it is determined as a result of monitoring by the monitoring unit that the load is equal to or higher than the certain value. Alternatively, in a case where a printing protocol and a printer port are used as a protocol and a port, it is also possible to employ a method in which when a printing instruction including a printing command and print data is transmitted by using this protocol and port, accumulated data is collectively transmitted together with this printing instruction. A program realizing the function of the transmission reception controller 105 may be provided, for example, as part of a driver program for causing an image forming apparatus to execute a printing process.

The usual communication controller 106 controls transmission and reception in usual data communication that does not use the unique protocol and port. For example, in a case where a printing protocol and a printer port are used as the unique protocol and port, data communication using the printing protocol and the printer port that is controlled by the transmission reception controller 105 is used for transmission of a printing command and print data that is an original purpose and transmission of data acquired by the measuring devices 171 and 172. Meanwhile, for example, Internet protocol (IP) communication that does not use a printing protocol and a printer port is used for setting of the image forming apparatus that serves as the information collecting server 200 or communication with another external device. The usual communication controller 106 controls such usual communication.

### Configuration of Information Collecting Server

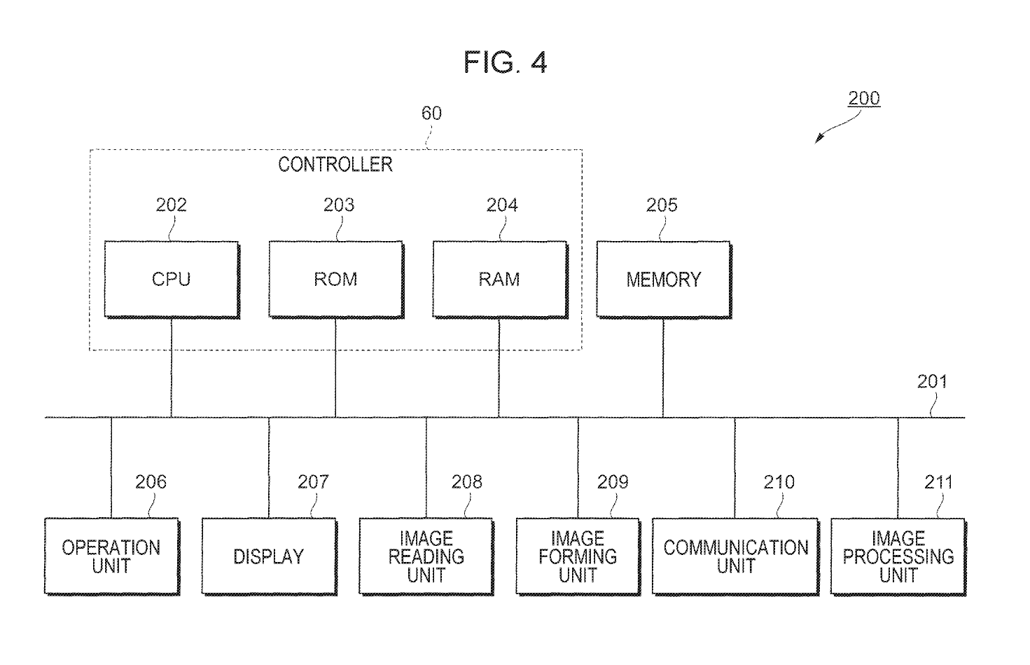

FIG. 4 illustrates a configuration of a multi-function printer that is an example of the information collecting server 200. In the configuration illustrated in FIG. 4, the information collecting server 200 includes a CPU 202, a read only memory (ROM) 203, and a RAM 204 that constitute a controller 60. The information collecting server 200 includes a memory 205, an operation unit 206, a display 207, an image reading unit 208, an image forming unit 209, a communication unit 210, and an image processing unit 211. These functional units are connected to a bus 201 and exchanges data through the bus 201.

The operation unit 206 receives a user's operation. The operation unit 206 is realized, for example, by a hardware key. Alternatively, the operation unit 206 is realized, for example, by a touch sensor that outputs a control signal according to a pressed position. The operation unit 206 may be a touch panel combining a touch sensor and a liquid crystal display that constitutes the display 207 that will be described later.

The display 207 is an example of a display and is realized, for example, by a liquid crystal display. The display 207 displays information concerning the information collecting server 200 under control of the CPU 202. Furthermore, the display 207 displays a menu screen that is referred to by a user when the user operates the information collecting server 200. That is, a combination of the operation unit 206 and the display 207 functions as a user interface unit of the information collecting server 200.

The image reading unit 208 is realized by a scanner device and generates a read image (image data) by optically reading an image of a placed document. Examples of an image reading system include a charge coupled device (CCD) system in which light emitted from a light source and reflected by a document is reduced by using a lens and is then received by a CCD and a contact image sensor (CIS) system in which light emitted from a light emitting diode (LED) light source and reflected by a document is received by a CIS.

The image forming unit 209 is an example of an image forming unit and forms an image based on image data on a sheet of paper that is an example of a recording material by using an image forming material. Examples of a system for forming an image on a recording material include an electrophotographic system for forming an image by transferring toner attached to a photoreceptor onto a recording material and an inkjet system for forming an image by ejecting ink onto a recording material.

The communication unit 210 has a network interface for connection to the information acquisition terminal 100 over the network 300. For example, a network adapter for connection through wired communication or a Wi-Fi module for connection using wireless communication is provided. Furthermore, the communication unit 210 has a communication interface used for other various kinds of communication. For example, the communication unit 210 has a FAX module for communication through a FAX communication line (telephone line). Furthermore, the communication unit 210 may have, as a communication interface, a module for short-range wireless communication such as near field radio communication (NFC) or Bluetooth (Registered Trademark).

The image processing unit 211 includes an processor that is an arithmetic processing unit and a working memory and performs image processing such as color correction and gradation correction on an image indicated by image data. The CPU 202 of the controller 60 may also serve as this processor, and the RAM 204 of the controller 60 may also serve as this working memory.

The memory 205 is an example of memory and is, for example, a storage device such as a hard disk device. The memory 205 stores therein image data such as a read image generated by the image reading unit 208. Furthermore, the memory 205 according to the present exemplary embodiment stores therein information for connection between the information acquisition terminal 100 and a terminal apparatus.

Among the CPU 202, the ROM 203, and the RAM 204 that constitute the controller 60, the ROM 203 stores therein a program executed by the CPU 202. The CPU 202 reads out the program stored in the ROM 203 and executes the program while using the RAM 204 as a working area. Alternatively, a program stored in the memory 205 may be loaded into the RAM 204, and the program loaded into the RAM 204 may be executed by the CPU 202. By execution of the program by the CPU 202, the functional units of the information acquisition terminal 100 are controlled, and the following functions are realized.

The program executed by the CPU 202 can be offered to the image forming apparatus that serves as the information collecting server 200 by being stored in a computer-readable recording medium such as a magnetic recording medium (e.g., a magnetic disc), an optical recording medium (e.g., an optical disc), or a semiconductor memory. The program executed by the CPU 202 may be offered to the image forming apparatus that serves as the information collecting server 200 over a network such as the Internet.

### Functional Configuration of Controller

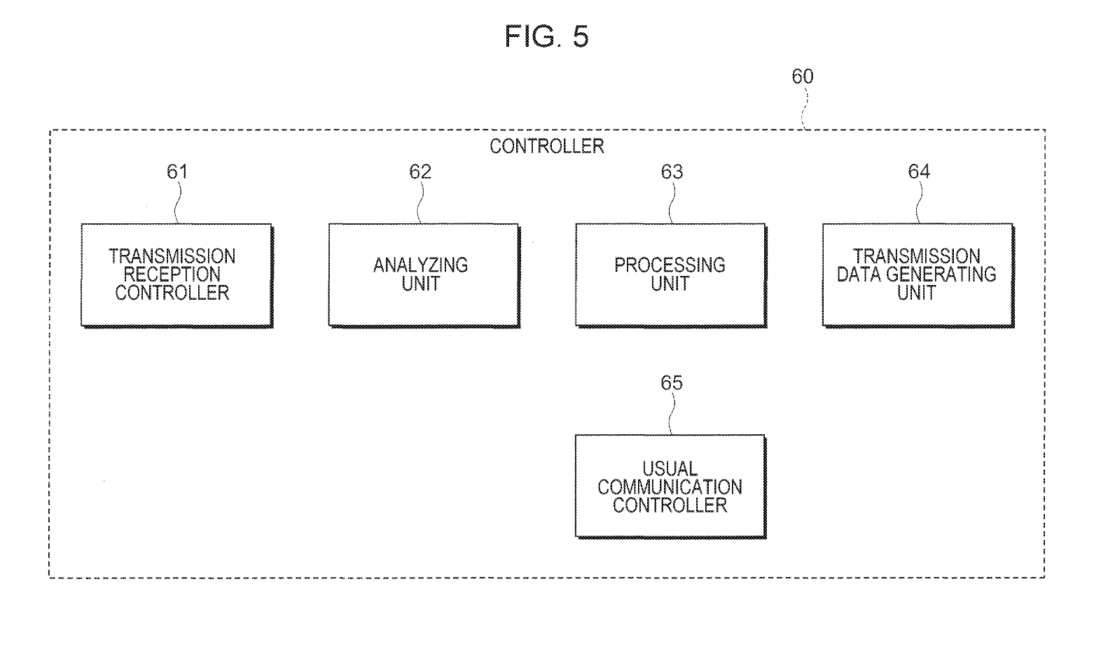

FIG. 5 illustrates a functional configuration of the controller 60. Through cooperation of software and hardware resources in the controller 60, the functions of a transmission reception controller 61, an analyzing unit 62, a processing unit 63, a transmission data generating unit 64, and a usual communication controller 65 are realized, as illustrated in FIG. 5.

The transmission reception controller 61 controls transmission and reception of data using unique protocol and port (a printing protocol and a printer port in this example) used for communication with the information acquisition terminal 100. Communication using a printing protocol and a printer port from the information collecting server 200 include communication of a printing instruction including a printing command and print data and communication including data to be collected that has been acquired by the measuring devices 171 and 172. The communication of a printing instruction including a printing command and print data may include data to be collected. The transmission reception controller 61 transmits a specific execution command executed by the information acquisition terminal 100 to the information acquisition terminal 100 by using the printing protocol and printer port.

The analyzing unit 62 extracts data to be collected that has been acquired by the measuring devices 171 and 172 by analyzing reception data received from the information acquisition terminal 100. The extracted data is held by a memory such as the memory 205 or the RAM 204.

The processing unit 63 sums up the data extracted by the analyzing unit 62. Specifically, for example, the processing unit 63 adjusts an information amount by rounding off fractions or performs a normalization process or other statistical processes, for example, in accordance with a purpose of use of the collected data.

The transmission data generating unit 64 generates transmission data on the basis of a printing protocol in a case where a control command to control functions of the information acquisition terminal 100 or data requested by the information acquisition terminal 100 is transmitted through communication using the printing protocol and a printer port.

The usual communication controller 65 controls transmission and reception in usual data communication that does not use unique protocol and port. Specifically, for example, IP communication is performed other than communication of data acquired by the measuring devices 171 and 172 and communication specially set to use a unique protocol. The usual communication controller 65 controls such usual communication.

### Configuration of Transmission Data

In the present exemplary embodiment, specific communication such as communication of data acquired by the measuring devices 171 and 172 is performed by using unique protocol and port (e.g., a printing protocol and a printer port) used for communication between the information acquisition terminal 100 and the information collecting server 200. A data structure of transmission data is described by taking transmission data based on a printing protocol as an example. In a case where data acquired by the measuring devices 171 and 172 is used as transmission data based on a printing protocol, only the acquired data is transmitted in a format based on the printing protocol or the acquired data is transmission together with a printing instruction including a printing command and print data.

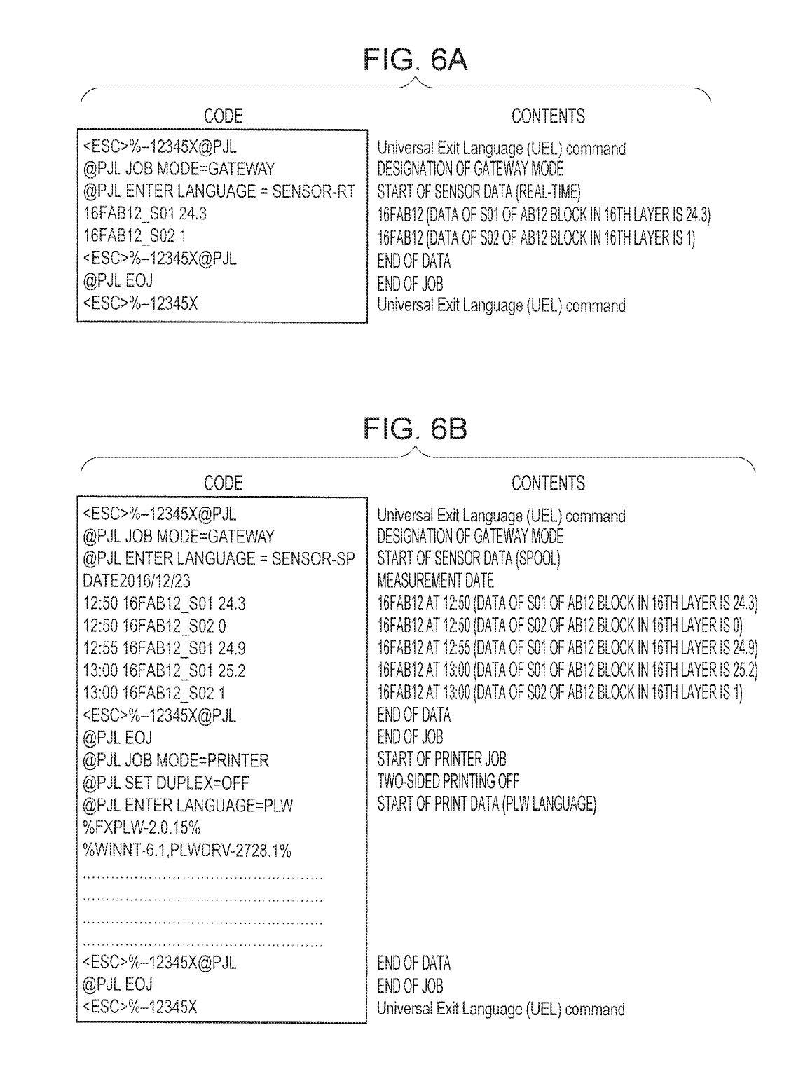

FIGS. 6A and 6B each illustrate an example of a configuration of transmission data. FIG. 6A illustrates an example of transmission data in a case where only acquired data is transmitted, and FIG. 6B illustrates an example of transmission data in a case where acquired data and a printing instruction are transmitted. In the examples illustrated in FIGS. 6A and 6B, transmission data is written in Printer Job Language (PJL).

In the example illustrated in FIG. 6A, the first line is a universal exit language (UEL) command for shifting to PJL. The second line is description for designating a gateway mode. The third line is description indicating the start of acquired data (sensor data). In this example, “SENSOR-RT” is described in the third line. This indicates that the acquired data is real-time data (data is transmitted instantly after acquisition). The fourth line and the fifth line describe the acquired data. For example, the fourth line indicates that “data (value) of S01 of an AB12 block of a 16th layer is 24.3”. The sixth line is description indicating the end of the acquired data. The seventh line is description indicating the end of the job. The eighth line (the last line) is a UEL command for shifting from PJL.

In the example illustrated in FIG. 6B, the first line and the second line describe the same contents as the first line and the second line in FIG. 6A. The third line is description indicating the start of acquired data (sensor data). In this example, “SENSOR-SP” is described in the third line. This indicates that the acquired data is spool data (data spooled in a memory is collectively transmitted). The fourth line is description indicating a date of acquisition (date of measurement) of the data. The fifth through ninth lines describe the acquired data. Each line describes a time of acquisition of the data, as compared with the description of the acquired data illustrated in FIG. 6A. The tenth line is description indicating the end of the acquired data, and the eleventh line is description indicating the end of the job. The twelfth line is description indicating the start of an image formation process (printer job). The thirteenth line is description of an instruction to turn off two-sided printing as a mode of a printing process. The fourteenth line is description indicating the start of print data in a PLW language, and the fifteenth line and the subsequent lines are description of print data (contents to be printed). The third line from the bottom is description indicating the end of the data, and the second line from the bottom is description indicating the end of the job. The last line is a UEL command shifting from PJL.

### Operation of Information Acquisition Terminal

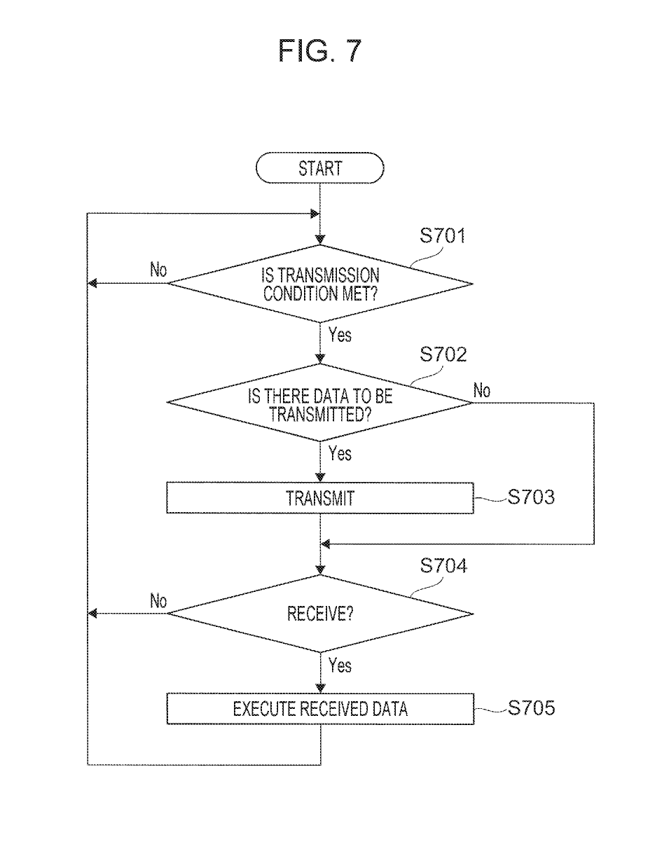

FIG. 7 is a flowchart illustrating an operation of the information acquisition terminal 100 in a case where acquired data is instantly transmitted. The following discusses an example in which transmission data is transmitted from a PC that serves as the information acquisition terminal 100 to an image forming apparatus that serves as the information collecting server 200. In a case where an acquired data transmission condition is met (S701), the transmission reception controller 105 (see FIG. 3) of the information acquisition terminal 100 determines whether or not data to be transmitted has been acquired (S702). In a case where the data has been acquired, the transmission data generating unit 102 generates transmission data, and the transmission reception controller 105 transmits the transmission data to the information collecting server 200 by using a printing protocol and a printer port (S703). Next, upon receipt of data from the information collecting server 200 (S704), the transmission reception controller 105 extracts an execution command by analyzing the received data and executes the execution command (S705).

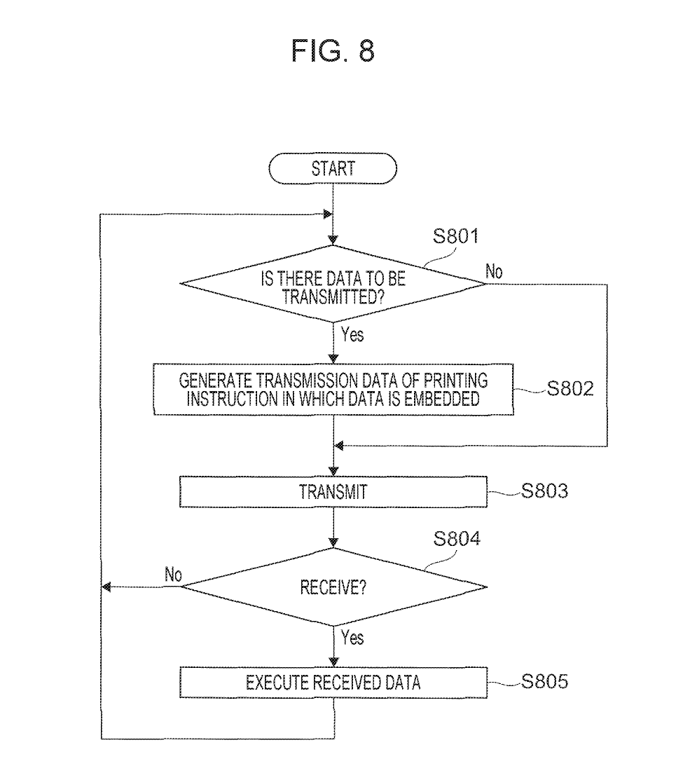

FIG. 8 is a flowchart illustrating an operation of the information acquisition terminal 100 in a case where acquired data is transmitted together with a printing instruction. When a printing instruction is transmitted to the information collecting server 200, the transmission reception controller 105 of the information acquisition terminal 100 determines whether or not data to be transmitted has been acquired (S801). In a case where the data has been acquired, the transmission data generating unit 102 generates transmission data of the printing instruction in which the acquired data is embedded (S802), and the transmission reception controller 105 transmits the printing instruction in which the acquired data is embedded by using a printing protocol and a printer port (S803). Meanwhile, in a case where the data has not been acquired, the transmission reception controller 105 transmits the printing instruction in which no acquired data is embedded by using a printing protocol and a printer port (S803). Next, upon receipt of data from the information collecting server 200 (S804), the transmission reception controller 105 extracts an execution command by analyzing the received data and executes the execution command (S805).

Communication using a printing protocol and a printer port is generally performed not from an image forming apparatus to a PC but from a PC to an image forming apparatus. Meanwhile, in a case where there is data to be transmitted from an image forming apparatus to a PC when acquired data is transmitted from the information acquisition terminal 100 as described above, the data is transmitted by using a printing protocol and a printer port.

### Operation of Information Collecting Server

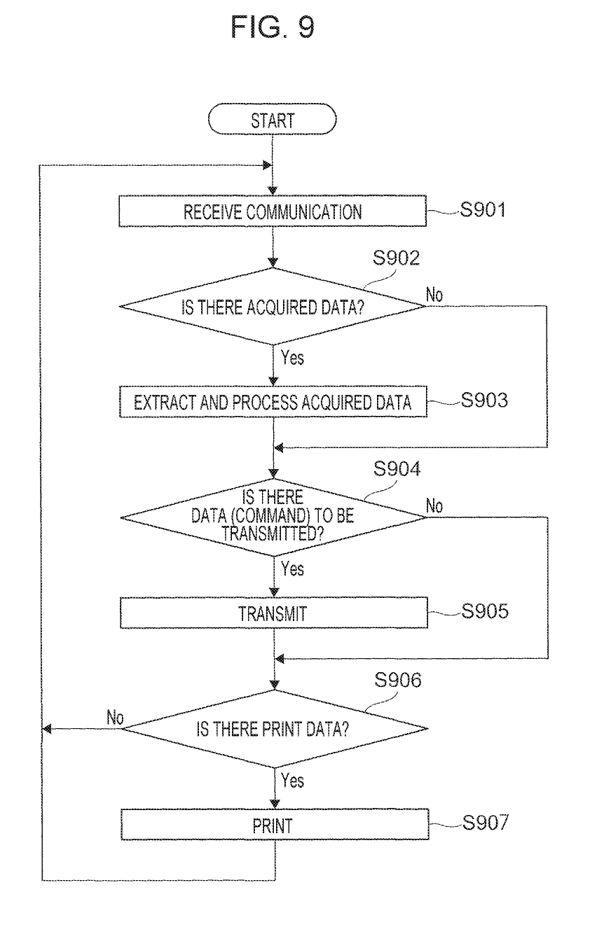

FIG. 9 is a flowchart illustrating an operation of the information collecting server 200 in a case where communication using a printing protocol and a printer port is performed. When the information collecting server 200 receives communication using a printing protocol and a printer port from the information acquisition terminal 100 (S901), the analyzing unit 62 of the information collecting server 200 examines whether or not received data includes data to be collected (acquired data) that has been acquired by the measuring devices 171 and 172 (S902). In a case where the received data includes the acquired data, the analyzing unit 62 extracts the acquired data, and the processing unit 63 processes the extracted data (S903).

Next, in a case where there is data to be transmitted (a command to be executed by a PC) (S904), the transmission reception controller 61 transmits the data through communication using the printing protocol and the printer port (S905). Then, the processing unit 63 determines whether or not the received data includes print data (S906). In a case where the received data includes print data, the processing unit 63 executes a printing process based on the print data (S907).

### Modifications

An example of an operation performed in a case where a printing protocol and a printer port are used has been described above as an example of communication using unique protocol and port between a personal computer (PC) serving as the information acquisition terminal 100 and an image forming apparatus serving as the information collecting server 200. However, the present exemplary embodiment is not limited to the above configuration and operation. For example, it is also possible to employ a configuration in which the image forming apparatus has a scanner function, and communication using a protocol for image reading and a port for scanner is performed as communication using unique protocol and port. In the present exemplary embodiment, it is only necessary that communication of data acquired by an information acquisition unit is performed by using unique protocol and port that is prepared separately from usual data communication such as IP communication. The information acquisition terminal 100, the information collecting server 200, and the protocol and port used for communication between the information acquisition terminal 100 and the information collecting server 200 are not limited to the above configurations.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information collecting system comprising:
an information processing apparatus; and
an image forming apparatus that forms an image on a recording material in accordance with an image formation command received from the information processing apparatus,
wherein the information processing apparatus includes an information acquisition unit that acquires specific information and a transmission control unit that transmits transmission data including the specific information acquired by the information acquisition unit to the image forming apparatus by using a communication protocol for the image formation command, and
wherein the image forming apparatus includes an information extraction unit that extracts the specific information from the transmission data received from the information processing apparatus and an information holding unit that holds the specific information extracted from the transmission data by the information extraction unit.

2. The information collecting system according to claim 1, wherein
the information acquisition unit is an external device connected to the information processing apparatus through a bus.

3. The information collecting system according to claim 2, wherein
the bus is a universal serial bus.

4. The information collecting system according to claim 1, wherein
the information acquisition unit is a measuring device included in the information processing apparatus.

5. The information collecting system according to claim 4, wherein
the information acquisition unit acquires information on an operator's operation of the information processing apparatus.

6. An information collecting system comprising:
an information processing apparatus; and
an operation apparatus that performs a specific operation in accordance with an operation command received from the information processing apparatus,
wherein the information processing apparatus includes an information acquisition unit that acquires specific information and a transmission control unit that transmits, to the operation apparatus, transmission data including the specific information that has been acquired by the information acquisition unit and that is not related to an operation of the operation apparatus based on the operation command by using a unique communication protocol, and
wherein the operation apparatus includes an information extraction unit that extracts the specific information from the transmission data received from the information processing apparatus and an information holding unit that holds the specific information extracted from the transmission data by the information extraction unit.

7. An image forming apparatus comprising:
a receiving unit that receives an image formation command by using a unique communication protocol;
an image formation unit that forms an image on a recording material in accordance with the received image formation command;
an information extraction unit that extracts specific information that is not used for image formation from reception data received from a specific terminal apparatus in accordance with the unique communication protocol;
a processing unit that performs specific processing on the specific information extracted from the reception data by the information extracting unit; and
a transmitting unit that transmits information processed by the processing unit to an external device.
